(19) United States
(12) Patent Application Publication
(10) Pub. No.: US 2026/0322083 A1
(43) Pub. Date: Oct. 15, 2026

(54) Lifting Device For A Cable and Cable Processing System

(71) Applicant: TE Connectivity Solutions GmbH, Schaffhausen (CH)

(72) Inventors: David Michael Stull, Middletown, PA (US); Ethan Pfautz, Middletown, PA (US)

(73) Assignee: TE Connectivity Solutions GmbH, Schaffhausen (CH)

(21) Appl. No.: 19/637,001

(22) Filed: Apr. 2, 2026

Related U.S. Application Data
(60) Provisional application No. 63/788,370, filed on Apr. 14, 2025.

(51) Int. Cl. H02G 1/00

(52) U.S. Cl. CPC H02G 1/00

(57) ABSTRACT

A lifting device for a cable includes a base, a cable arm support attached to the base and movable with respect to the base along a vertical direction between a retracted position and an extended position, and a pair of cable gripping arms mounted to the cable arm support. The cable gripping arms are pivotable with respect to the cable arm support in an extended position of the cable arm support to grip the cable between the cable gripping arms.

### CROSS-REFERENCE TO RELATED APPLICATION

This application claims priority under 35 U.S.C. § 119 to U.S. Provisional Patent Application No. 63/788,370, filed on Apr. 14, 2025.

### FIELD OF THE INVENTION

The present disclosure relates to electrical cable processing, and more particularly, to a system and method for lifting or supporting a cable as it is introduced into a cable processing machine.

### BACKGROUND

The preparation of wire and cable for use in electrical systems is time consuming and expensive. High voltage electrical cable is one such application requiring significant effort to process the cable ends prior to use. In order to accurately position the cable for processing, existing art relies on a funnel to guide the cable during processing into the cutting head. As cable processing lengths increase, the flexible nature of the cable results in deflection of cable between the cable gripping assembly and the cable end. This deflection can result in the cable tip missing the inlet of the alignment funnel. Additionally, the column strength of the cable decreases exponentially as the cable diameter is reduced and the required processing length increases, leading to greater deflection.

Accordingly, there is a need for a compact mechanism that can quickly collect a cable if it is experiencing a large vertical or horizontal deformation.

### SUMMARY

A lifting device for a cable includes a base, a cable arm support attached to the base and movable with respect to the base along a vertical direction between a retracted position and an extended position, and a pair of cable gripping arms mounted to the cable arm support. The cable gripping arms are pivotable with respect to the cable arm support in an extended position of the cable arm support to grip the cable between the cable gripping arms.

### BRIEF DESCRIPTION OF THE DRAWINGS

The invention will now be described by way of example with reference to the accompanying Figures, of which:

FIG. 1 is a perspective view of a cable processing machine including a cable lift or lifting device according to an embodiment of the present disclosure in an initial or retracted position;

FIG. 2 is a partial perspective view of the cable processing machine of FIG. 1 with the cable lift in a partially extended position;

FIG. 3 is a perspective view of the cable lift according to an embodiment of the present disclosure;

FIG. 4 is a partial front view of the cable lift according to an embodiment of the present disclosure;

FIG. 5 is another partial front view of the cable lift according to an embodiment of the present disclosure with a gripping arm thereof shown separated from a remainder of the cable lift;

FIG. 6 is a side view of the cable lift according to an embodiment of the present disclosure; and

FIG. 7 is a schematic diagram of a control system adapted to perform the cable lifting methods according to embodiments of the present disclosure.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Embodiments of the present disclosure include a cable lift or lifting device for a cable preparation system. The system incorporates a linearly guided device that enables long extension of an alignment or gripping mechanism. Along with the cable preparation system, these systems collect and center the cable during the stripping process, ensuring precise and controlled preparation for subsequent connectorization. The linear guidance minimizes friction and wear, enhancing the system's durability and operational efficiency. The benefit of the present embodiments of the disclosure is to allow shorter cables to process. Without the device according to embodiments of the present disclosure, cable processing lengths reach a point that they deflect too significantly and can no longer be reliably aligned with a funnel. In this instance, embodiments described herein can quickly be deployed to ensure that the cable is centered with the cutting head, and further, to provide a second point of support on the column of cable to prevent buckling when inserting into an alignment funnel or cutting head. Existing art relies on a cable that has minimal deformation to ensure proper alignment with the processing equipment. Beneficially, the instant lifting device can collect cables with larger horizontal and vertical deformation, expanding the production capabilities of existing cable processing machines.

Other variations, modifications, or enhancements may be possible. For example, while the invention is adapted to collect and guide the cable only, it is possible the design could also grip the cable to allow repositioning of the primary cable gripping mechanism to allow longer cable stripping lengths. Additionally, sensors could be added to permit inspection of the processing quality. The invention could also have replaceable guidance arms that can be configured to specific cables for increased performance.

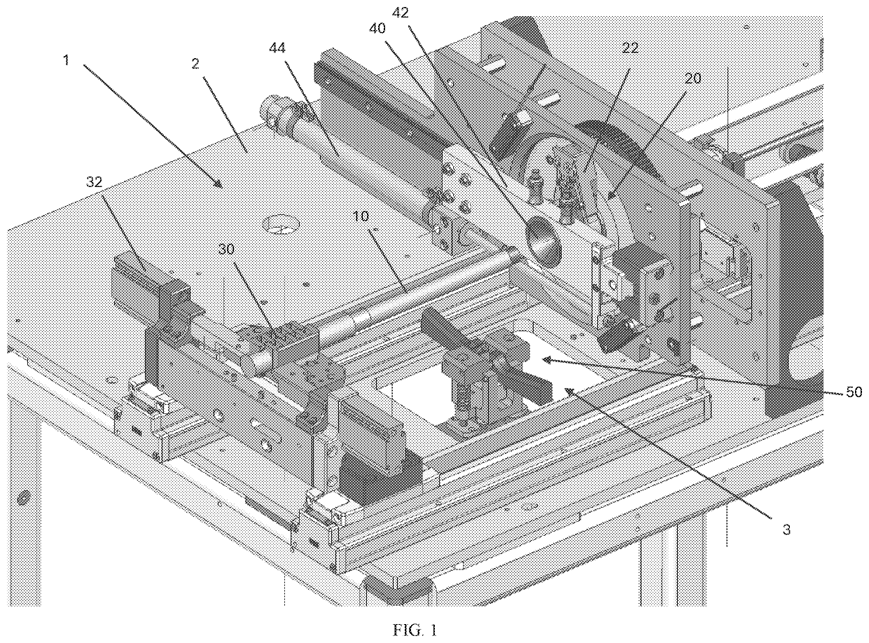

Referring generally to FIG. 1, a cable processing system 1 according to embodiments of the present disclosure includes a platform 2 having an exemplary cable processing machine, such as an HV-CP (“High Voltage Cable Processor”) processing machine 20 mounted thereto. The machine 20 includes a plurality of cutting heads 22 adapted to process a cable 10 (e.g., strip, cut, flair etc.). The cable 10 is secured via a clamp assembly 30, which may include end actuators 32 for controlling the clamp assembly 30 and/or translate the clamp assembly 30 and thus the cable 10 toward the cable processing machine 20. As described above, the cable 10 is fed into a funnel 40 for final alignment with the cable processing machine 20. The funnel 40 may be moveably mounted to a base plate 42 that is translatable via an actuator 44.

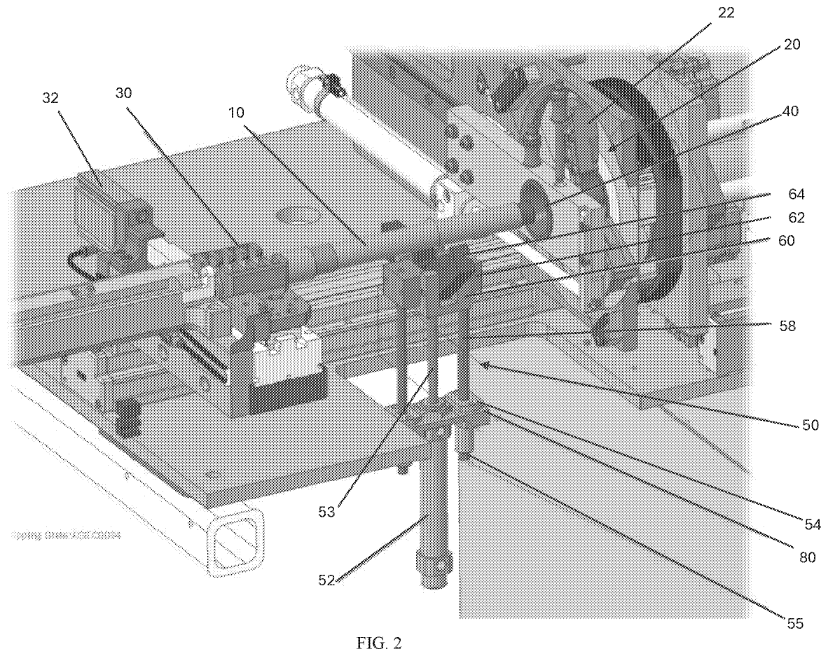

Still referring to FIG. 1, as described above, in order to obtain greater control of the cable 10 intermediately along its length, particularly for cables with lower stiffness and greater deflection over its length, embodiments of the present disclosure are directed to a lift system or lifting device 50 which may be selectively used as needed by an operator depending the nature of the cable to be processed (e.g., length, diameter etc.). In the stored or retracted position of FIG. 1, the lifting device 50 is arranged within a window or opening 3 formed in the platform 2 so as not to interfere with cable processing operations while not in use. An intermediate or partially extended position of the lifting device 50 is shown in FIG. 2, wherein the system is in use.

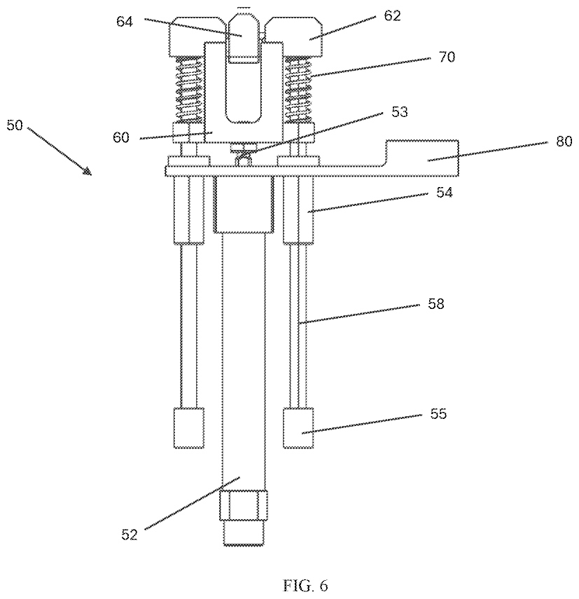

Referring generally now to FIGS. 2-6, the lifting system or device 50 includes a linear actuator 52 (e.g., a pneumatic cylinder) including a moveable rod or end 53. In the exemplary embodiment, the actuator 52 is mounted to a base 80. The base 80 further includes a pair of bearings or bushings 54 through which two cylindrical guide rods 58 are slidably arranged and adapted to move in the vertical direction. The lower ends of each of the guide rods 58 are fitted with mechanical stops 55, such that their travel is limited in the vertically upward direction. It should be understood that the length of the guide rods may be changed according to the application (e.g., the cable being processed).

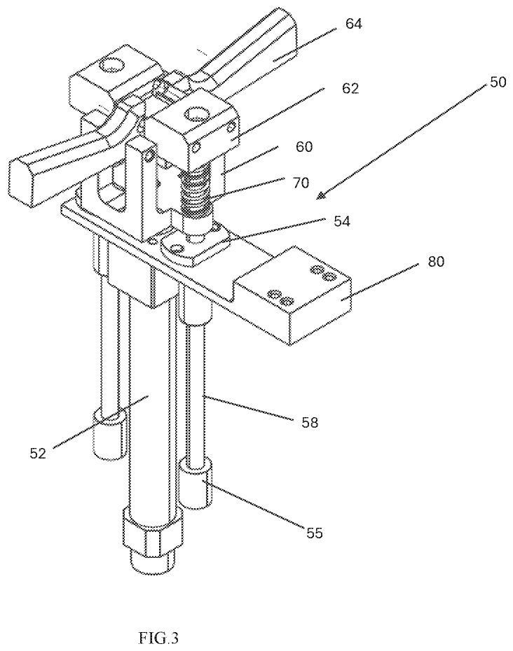

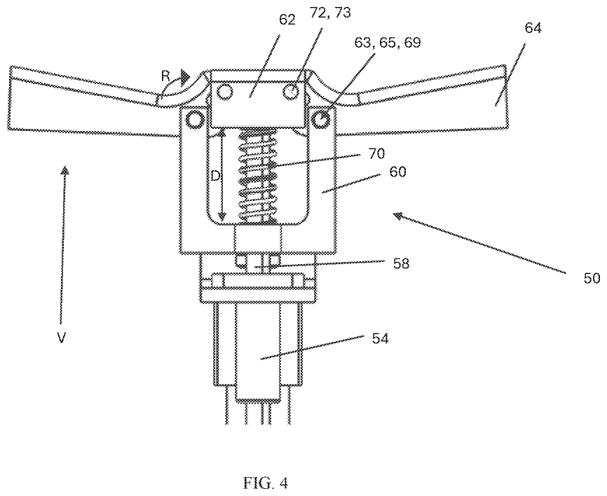

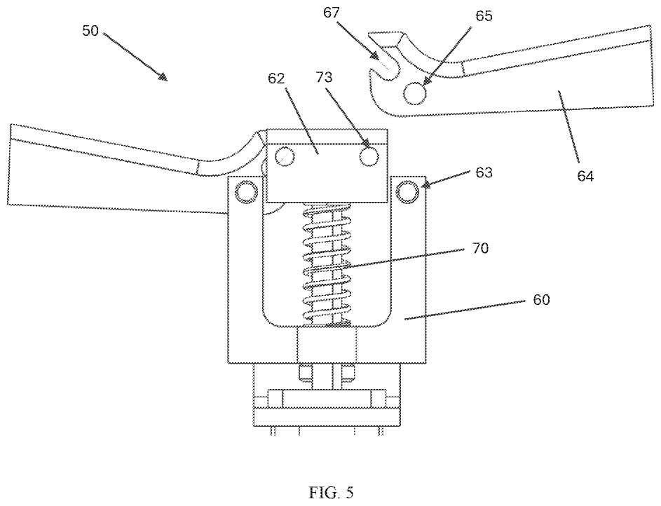

As most clearly shown in FIGS. 3-6, upper ends of the guide rods 58 are fixedly connected to a respective one of a pair of arm guides or blocks 62. A cable arm support or support structure 60 is fitted to the moveable end 53 of the actuator 52. Cable gripping arms 64 are pivotally mounted to the cable arm support 60 via concentric through holes 63, 65 through which a pin or fastener 69 is passed, as shown in FIG. 4. Concentric openings or through holes are also formed through the pair of arm guide blocks 62 thorough which a pin or other fastener 73 is passed. As shown in FIG. 5, the arm 64 (displaced for clarity) includes a slot 67 formed therein for accepting the fastener 73 in a sliding/rotating manner. A pair of compression springs 70 are fitted over each of the each of the guide rods 58 and are arranged between the cable arm support 60 and each of the arm guides 62.

As can be visualized with reference to FIGS. 2-6, the actuator 52 is adapted to be quickly extended upwards in order to support the cable 10 without the gripping arms 64 being actuated, or not fully actuated, such as shown in FIG. 2. In this position, the mechanical stops 55 limit an extension height of the gripping assembly 60, 62, 64, specifically by fixing a vertical position of the arm guides 62.

In order to perform a second step of grasping the cable 10, the cable arm support 60 is continued to be biased in the vertical direction by the actuator 52, for example in a relatively slow/controlled manner compared to the speed of the initial extension. As is most clearly shown in FIG. 4, biasing the cable arm support 60 further vertically upward in the indicated direction V, a distance D between the cable arm support 60 and the arm guides 62 is reduced. This action rotates the arms 64 in the indicated direction(s) R, closing the arms as the pin or fastener 73 is translated within the slot 67 in the indicated direction. It should be understood that closing of the arms 64 is resisted by the pair of springs 70 arranged between cable arm support 60 and the arm guides 62. The springs 70 are adapted to, inter alia, control a gripping force applied by the arms 64 on the cable 10, as well as aid in returning the arms to their initial open position upon retraction of the actuator 52.

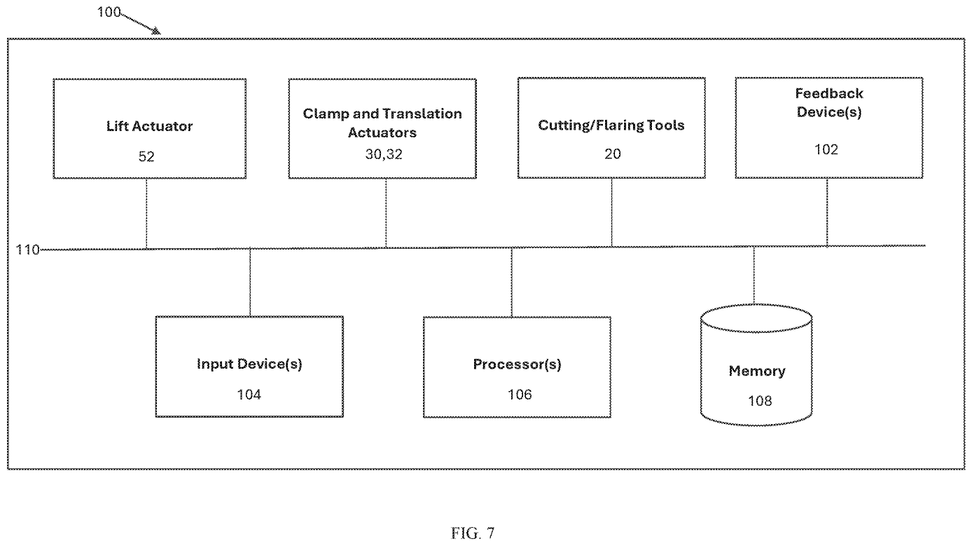

Methods according to embodiments of the present invention may be performed wholly or in part by one or more automated control systems implementing and/or controlling the above-described components, as well as additional hardware and software features. For example, referring generally to FIG. 7, an exemplary control system 100 useful for performing the operations of the embodiments of the present disclosure is shown. The control system 100 may be under fully automated control, or fully or partially controlled via one or more user input devices 104 (e.g., touch screen/buttons/keyboards, etc.). The control system 100 includes at least one processor 106, such as a digital microprocessor responsive to instructions stored on a memory device 108 for performing the methods or operations described herein. The processor 106 is operatively coupled to the above-described actuators 30, 32, 52 for controlling the operation of the system 100 as set forth above. The control system 100 may further include feedback devices 102 such as one or more sensors and/or cameras, which may be operative with the processor 106 to monitor system performance in real-time and adjust operating parameters in order to ensure repeated and accurate cable handling. The system 100, and more specifically the processor 106, may also be used to control the cable processing machine 20.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A lifting device for a cable, comprising:
a base;
a cable arm support attached to the base and movable with respect to the base along a vertical direction between a retracted position and an extended position; and
a pair of cable gripping arms mounted to the cable arm support, the cable gripping arms are pivotable with respect to the cable arm support in an extended position of the cable arm support to grip the cable between the cable gripping arms.

2. The lifting device of claim 1, further comprising a linear actuator attached to the base and having a moveable rod attached to the cable arm support.

3. The lifting device of claim 2, wherein the linear actuator, by motion of the moveable rod, moves the cable arm support between the retracted position and the extended position.

4. The lifting device of claim 2, further comprising a pair of arm guides movably disposed on the cable arm support and engaging the pair of cable gripping arms.

5. The lifting device of claim 4, wherein, as the linear actuator drives the cable support to the extended position, the arm guides move with respect to the cable arm support and pivot the cable gripping arms into contact with the cable.

6. The lifting device of claim 5, further comprising a pair of guide rods extending through the base and connected to the pair of arm guides, the guide rods move with respect to the base and guide movement of the arm guides.

7. The lifting device of claim 6, wherein each of the guide rods has a mechanical stop on an end of the guide rod opposite the arm guide, the mechanical stop limits movement of the guide rods and the arm guides in the vertical direction as the cable arm support moves toward the extended position.

8. The lifting device of claim 7, wherein the arm guides move with respect to the cable arm support when the guide rods reach the mechanical stops and the linear actuator continues to move the cable arm support to the extended position.

9. The lifting device of claim 8, wherein each of the guide rods has a compression spring arranged between the cable arm support and one of the arm guides.

10. The lifting device of claim 9, wherein the compression springs are compressed as the cable gripping arms pivot to grip the cable, the compressions springs bias the cable gripping arms into an open position.

11. The lifting device of claim 5, wherein each of the cable gripping arms has a slot on an end of the cable gripping arm, the arm guides each have a fastener disposed in the slot, the fasteners slide in the slots to pivot the cable gripping arms as the arm guides move with respect to the cable arm support.

12. A cable processing system, comprising:
a clamp assembly;
a cable processing machine spaced apart from the clamp assembly;
a cable held by the clamp assembly and extending from the clamp assembly toward to the cable processing machine; and
a lifting device positioned between the clamp assembly and the cable processing machine, the lifting device includes a base, a cable arm support attached to the base and movable with respect to the base along a vertical direction between a retracted position and an extended position, and a pair of cable gripping arms mounted to the cable arm support, the cable gripping arms are pivotable with respect to the cable arm support in an extended position of the cable arm support to grip the cable between the cable gripping arms.

13. The cable processing system of claim 12, wherein the lifting device limits deformation of the cable to align the cable with the cable processing machine.

14. The cable processing system of claim 12, further comprising a funnel arranged between the lifting device and the cable processing machine, the funnel provides final alignment of the cable with the cable processing machine.

15. The cable processing system of claim 12, further comprising a platform supporting the clamp assembly and the cable processing machine, the lifting device is positioned in a window of the platform in the retracted position.

16. The cable processing system of claim 12, wherein the clamp assembly has an end actuator that translates the clamp assembly toward the cable processing machine.

17. The cable processing system of claim 12, further comprising a control system connected to and controlling the clamp assembly, the cable processing machine, and the lifting device to process the cable.

18. A method of operating a cable processing system, comprising:
clamping a cable with a clamp assembly, the clamp assembly is spaced apart from a cable processing machine that processes the cable;
positioning a lifting device between the clamp assembly and the cable processing machine, the lifting device includes a base, a cable arm support attached to the base and movable with respect to the base along a vertical direction between a retracted position and an extended position, and a pair of cable gripping arms mounted to the cable arm support; and
supporting the cable between the clamp assembly and the cable processing machine with the lifting device by moving the cable arm support to the extended position and pivoting the cable gripping arms into contact with the cable.

19. The method of claim 18, wherein the lifting device has a linear actuator that moves the cable arm support from the retracted position to an intermediate position between the retracted position and the extended position, the cable gripping arms do not contact the cable in the intermediate position.

20. The method of claim 19, wherein the cable arm support moves more quickly between the retracted position and the intermediate position than between the intermediate position and the extended position.
